(19) United States
(12) Patent Application Publication
(10) Pub. No.: US 2007/0130268 A1
(43) Pub. Date: Jun. 7, 2007

(54) Information processing apparatus and communication control method

(76) Inventor: Hiroyuki Tsuji, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/602,124

(22) Filed: Nov. 20, 2006

(30) Foreign Application Priority Data
Nov. 29, 2005 (JP) 2005-344101

(51) Int. Cl. G06F 15/16

(52) U.S. Cl. 709/206

(57) ABSTRACT

According to one embodiment, an information processing apparatus includes a wireless communication device, a first system, and a second system. The first system is configured to operate under a control of an operating system. The first system executes, when a main body of the apparatus is in a power-on state, a process of performing wireless communication with an external device by using the wireless communication device and receiving data from the external device, and a process of storing the received data in a first storage device. The second system is configured to operate independently from the first system. The second system executes, when the main body is in a power-off state, a communication process of performing wireless communication with the external device by using the wireless communication device and receiving data from the external device, and a process of storing the received data in a second storage device.

### CROSS-REFERENCE TO RELATED APPLICATIONS

This application is based upon and claims the benefit of priority from Japanese Patent Application No. 2005-344101, filed Nov. 29, 2005, the entire contents of which are incorporated herein by reference.

### BACKGROUND

1. Field

One embodiment of the invention relates to an information processing apparatus such as a personal computer, and more particularly to an information processing apparatus including a wireless communication device and a communication control method for use in the apparatus.

2. Description of the Related Art

In recent years, various types of battery-powerable portable personal computers, such as a laptop type computer or a notebook type computer, have been developed. This type of computer includes a wireless communication device which executes wireless communication with an external device.

The use of the wireless communication device enables the computer to execute communication, such as transmission/reception of e-mail or access to Web sites, at any place regardless of where the computer is used.

Jpn. Pat. Appln. KOKAI Publication No. 2003-256090 discloses an information terminal which executes communication with outside by wire or wirelessly, using a card type communication adapter having both a wired communication function and a wireless communication function.

In usual cases, however, a communication process, such as reception of e-mail, cannot be executed unless the computer is powered on to start the operating system.

It has thus been desired to realize a novel function for automatically executing, without powering on the computer, the communication process for receiving data, such as e-mail, from an external device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of the external appearance of an information processing apparatus, as viewed from the front side, according to an embodiment of the invention;

FIG. 2 is an exemplary perspective view showing an example of the external appearance of the information processing apparatus shown in FIG. 1 in the state in which a display unit is closed;

FIG. 3 is an exemplary block diagram showing an example of the system configuration of the information processing apparatus shown in FIG. 1;

FIG. 4 illustrates an example of transition of system states of the information processing apparatus shown in FIG. 1;

FIG. 5 is an exemplary flow chart illustrating an example of the basic procedure of a Notification process which is executed by the information processing apparatus shown in FIG. 1;

FIG. 6 is an exemplary flow chart illustrating an example of the specific procedure of the Notification process which is executed by the information processing apparatus shown in FIG. 1;

FIG. 7 shows an example of a setup screen which is displayed by the information processing apparatus shown in FIG. 1;

FIG. 8 shows an example of a display screen of a sub-display which is provided on the information processing apparatus shown in FIG. 1; and

FIG. 9 is an exemplary block diagram showing another example of the system configuration of the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes: a main body; a wireless communication device which is provided in the main body; a first system which is provided in the main body and is configured to operate under a control of an operating system, the first system executing, when the main body is in a power-on state, a process of performing wireless communication with an external device by using the wireless communication device and receiving data from the external device, and a process of storing the received data in a first storage device; and a second system which is provided in the main body and is configured to operate independently from the first system, the second system executing, when the main body is in a power-off state, a communication process of performing wireless communication with the external device by using the wireless communication device and receiving data from the external device, and a process of storing the received data in a second storage device.

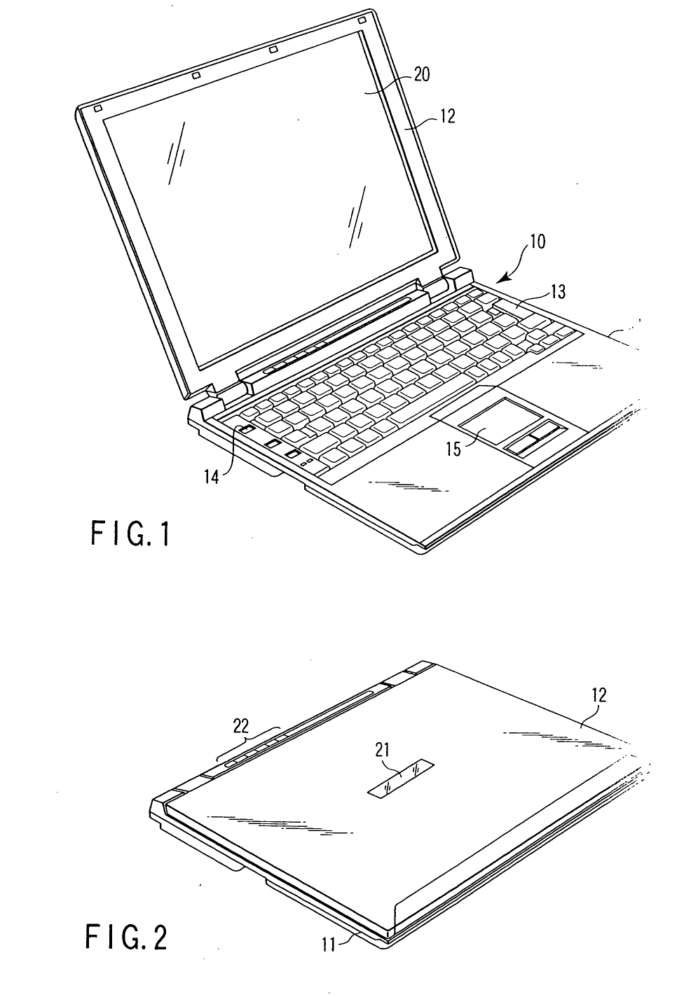

To begin with, the structure of an information processing apparatus according to an embodiment of the invention is described referring to FIG. 1 and FIG. 2. The information processing apparatus is realized as a battery-powerable notebook-type portable personal computer 10. This computer 10 has a function of automatically executing a communication process for receiving data, such as e-mail, while the computer 10 is kept in a power-off state, storing the received data, and informing a user of the reception of data. In the description below, this function is referred to as “Notification function”.

FIG. 1 is a perspective view showing the computer 10, as viewed from the front side, in the state in which a display unit is opened.

The main body of the computer 10 comprises a base unit 11 and a display unit 12. A display device that is composed of an LCD (Liquid Crystal Display) 20 is built in the display unit 12. The display screen of the LCD 20 is positioned at an approximately central part of the display unit 12.

The display unit 12 is supported on the base unit 11 such that the display unit 12 is freely rotatable, relative to the base unit 11, between an open position where the top surface of the base unit 11 is exposed and a closed position where the top surface of the base unit 11 is covered by the display unit 12. The base unit 11 has a thin box-shaped casing. A keyboard 13, a power button 14 for powering on/off the main body of the computer 10, and a touch pad 15 are disposed on the top surface of the base unit 11. A wireless communication device is built in the base unit 11. In the Notification function, the wireless communication device is used to execute wireless communication with an external device such as a mail server or another computer.

FIG. 2 is a perspective view showing the external appearance of the computer 10 in the state in which the display unit 12 is closed. A sub-display 21 is disposed on the back surface of the display unit 12. The sub-display 21 is a display device for use in displaying various status information relating to the Notification function. For example, the sub-display 21 displays information which is indicative of an electric field intensity level of a radio signal from a base station, and Notification information for notifying the user of reception of new data such as e-mail. Needless to say, reception data itself may be displayed as Notification information on the screen of the sub-display 21. For example, information (subject, sender, date/time) that is included in the header of received e-mail may be displayed on the sub-display 21 as Notification information. In addition, the body of the received e-mail may be displayed on the sub-display 21.

The sub-display 21 enables the user to confirm the reception of new e-mail and to view the content of the new e-mail, even in the state in which the computer 10 is powered off and the display unit 12 is closed.

An operation switch 22 is provided on the rear part of the base unit 11. The operation switch 22 includes some push button switches which are used in order to control the display content of the sub-display 21. The push button switches include, for example, a push button switch for designating scroll-up of display content on the screen of the sub-display 21, and a push button switch for designating scroll-down of display content on the screen of the sub-display 21. Even in the state in which the display unit 12 is closed, the operation switch 22 is exposed to outside. The user may operate the operation switch 22 in the state in which the display unit 12 is closed, thus being able to view the content of the body of the e-mail displayed on the sub-display 21 while scrolling the displayed content.

The position of the sub-display 21 is not limited to the back surface of the display unit 12. The sub-display 21 may be disposed at any arbitrary position on the main body of the computer 10, which is exposed to outside in the state in which the display unit 12 is closed.

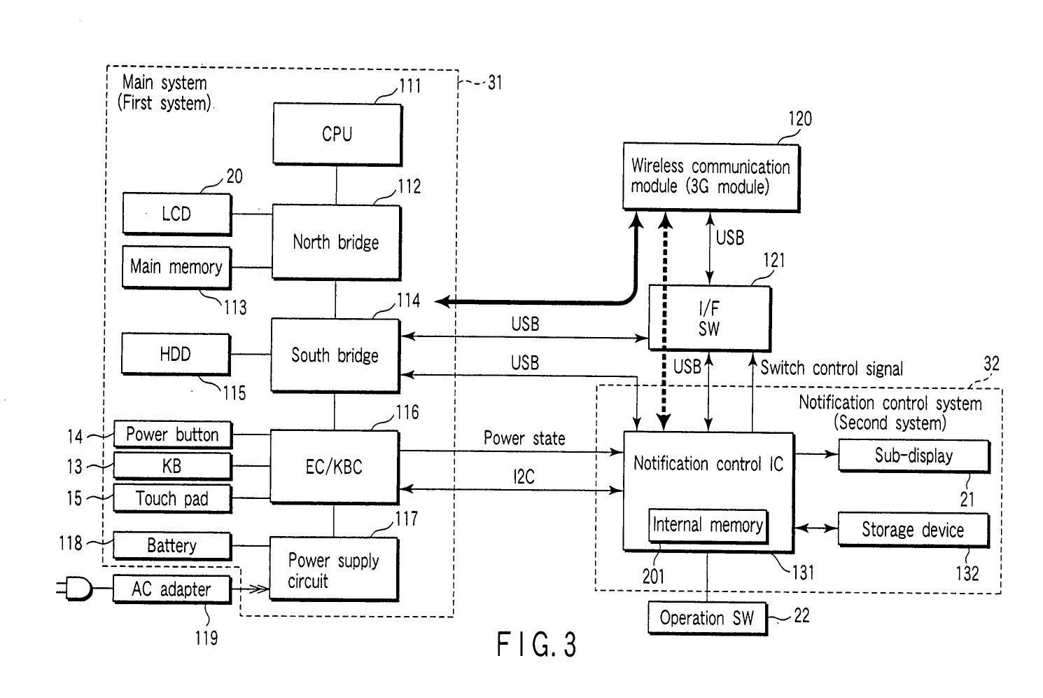

FIG. 3 shows an example of the system configuration of the computer 10.

The computer 10 comprises a first system, a second system and a wireless communication device 120.

The first system is a main system which is configured to operate under the control of the operating system, and is provided within the base unit 11. This main system 31 operates when the main body of the computer 10 is powered on. The main system 31 includes a CPU 111, a north bridge 112, a main memory 113, a south bridge 114, a hard disk drive (HDD) 115, an embedded controller/keyboard controller IC (EC/KBC) 116, and a power supply circuit 117.

The CPU 111 is a main processor that controls the operation of the computer 10. The CPU 111 executes an operating system and various application programs/utility programs, which are loaded from the HDD 115 into the main memory 113. An example of the application programs is mail software (mailer) for executing transmission/reception of e-mail. The CPU 111 executes the mailer, thereby carrying out a process for sending e-mail to an external device, such as a mail server, and a process for receiving e-mail from an external device such as a mail server. The mailer manages a predetermined storage area in the HDD 115 as a receiving tray area, and stores received e-mails in the receiving tray area.

The north bridge 112 is a bridge device that connects a local bus of the CPU 111 and the south bridge 114. The north bridge 112 includes a display controller which controls the LCD 20 functioning as a main display of the computer 10, and a memory controller which controls the main memory 113.

The south bridge 114 functions as an I/O controller for controlling various I/O devices. The south bridge 114 includes an IDE (Integrated Drive Electronics) controller for controlling the HDD 115, and a USB (Universal Serial Bus) host controller for controlling a USB device. The south bridge 114 is connected to the wireless communication device 120 via a serial bus, such as a USB, and an interface switch circuit 121. Further, the south bridge 114 is connected to a Notification control system 32, which functions as the above-mentioned second system, via a serial bus such as a USB.

The embedded controller/keyboard controller IC (EC/KBC) 116 is a 1-chip microcomputer in which an embedded controller for power management and a keyboard controller for controlling the keyboard (KB) 13 and touch pad 15 are integrated. The embedded controller/keyboard controller (EC/KBC) 116 cooperates with the power supply circuit 117 and powers on/off the computer 10 in response to the user's operation of the power button 14. The power supply circuit 117 generates operation power, which is to be supplied to the components of the computer 10, using power from a battery 118, or external power from an AC adapter 119. Even when the computer 10 is in the power-off state, the EC/KBC 116 is supplied with operation power from the power supply circuit 117.

The Notification control system 32, which functions as the second system, executes the above-described Notification function. The Notification control system 32 is configured to operate independently from the main system 31. Even when the computer 10 is in the power-off state, that is, even when the main system 31 is in the power-off state, the Notification control system 32 is supplied with operation power from the power supply circuit 117. The Notification control system 32 is a dedicated system for executing the above-described Notification function. The power consumption of the Notification control system 32 is much lower than that of the main system 31.

The Notification control system 32 includes a Notification control IC 131, the above-mentioned sub-display 21 and a storage device 132. The Notification control system IC 131 is a processor for controlling the operation of the Notification control system 32, and is composed of, e.g. a 1-chip microcomputer. The Notification control IC 131 executes a program which is stored in the storage device 132 or an internal memory 201. This program includes e-mail software (mailer) for receiving e-mail from an external device such as a mail server. For example, the mailer is composed of only a minimum necessary functional module for receiving e-mail. The Notification control IC 131 is connected to the south bridge 114 in the main system 31 via a serial bus such as a USB. The Notification control IC 131 is also connected to the EC/KBC 116 in the main system 31 via a serial bus such as an I²C (Inter-IC) bus. Further, the Notification control IC 131 is connected to the wireless communication device 120 via a serial bus, such as a USB, and the interface switch circuit 121.

The Notification control IC 131 executes the mailer which is stored in the storage device 132 or the internal memory 201, and executes a communication process for receiving data, such as e-mail, from an external device. This communication process is executed while the computer 10 is in the power-off state, that is, while the main system 31 is in the power-off state. Data, such as received e-mail, is stored in the storage device 132 or internal memory 201, which is provided in the Notification control system 32. The Notification control IC 131 also has a function of controlling the sub-display 21.

The interface switch circuit 121 is a switch circuit which selectively connects one of the main system 31 and Notification control system 32 to the wireless communication device 120. In response to the power-off of the main body of the computer 10, the interface switch circuit 121 connects the Notification control system 32 to the wireless communication device 120. In addition, in response to the power-on of the main body of the computer 10, the interface switch circuit 121 connects the main system 31 to the wireless communication device 120. The switching operation of the interface switch circuit 121 is controlled, for example, by the Notification control IC 131.

The wireless communication device 120 executes wireless communication with a base station according to a wireless communication standard such as 3 G Wireless WAN. The 3 G Wireless WAN is a wide-area wireless network such as a mobile telephone network. Even when the computer 10 is in the power-off state, that is, the main system 31 is in the power-off state, the wireless communication device 120 is supplied with operation power from the power supply circuit 117.

In the computer 10, the main system 31 and Notification control system 32 are electrically connected to the wireless communication device 120. The wireless communication device 120 is shared by the main system 31 and Notification control system 32. When the main body of the computer 10 is powered on, the wireless communication device 120 is connected to the main system 31 via the interface switch circuit 121, as indicated by a thick solid line in FIG. 3, and the wireless communication device 120 is used by the main system 31. On the other hand, when the main body of the computer 10 is powered off, that is, when the main system 31 is powered off, the wireless communication device 120 is connected to the Notification control system 32 via the interface switch circuit 121, as indicated by a broken line in FIG. 3, and the wireless communication device 120 is used by the Notification control system 32.

When the main body of the computer 10 is in the power-on state, the main system 31 executes mail software which runs on the operating system. Under the control of the operating system and mail software, the main system 31 executes wireless communication with an external device by using the wireless communication device 120, and carries out a process for receiving data, such as e-mail to the computer 10, from the external device and a process for storing the received data in the HDD 115 which serves as a first storage device.

On the other hand, when the main body of the computer 10 is in the power-off state, the Notification control system 32 executes, under the control of the mail software stored in the internal memory 201 or storage device 132, wireless communication with an external device by using the wireless communication device 120, and carries out a process for receiving data, such as e-mail to the computer 10, from the external device and a process for storing the received data in the internal memory 201 or storage device 132 which serves as a second storage device. The Notification control system 32 also executes a process for displaying, on the screen of the sub-display 21, the above-mentioned Notification information which indicates reception of data such as e-mail. If the main body of the computer 10 is powered on, the Notification control system 32 also executes a process for transferring the reception data, such as e-mail, which is stored in the internal memory 201 or storage device 132, to the main system 31 via the serial bus such as a USB.

As described above, in the computer 10, the wireless communication device 120 is connected to the main system 31 and Notification control system 32. Thus, no matter whether the computer 10 is in the power-on state or in the power-off state, the communication process with the external device can be executed by using the wireless communication device 120.

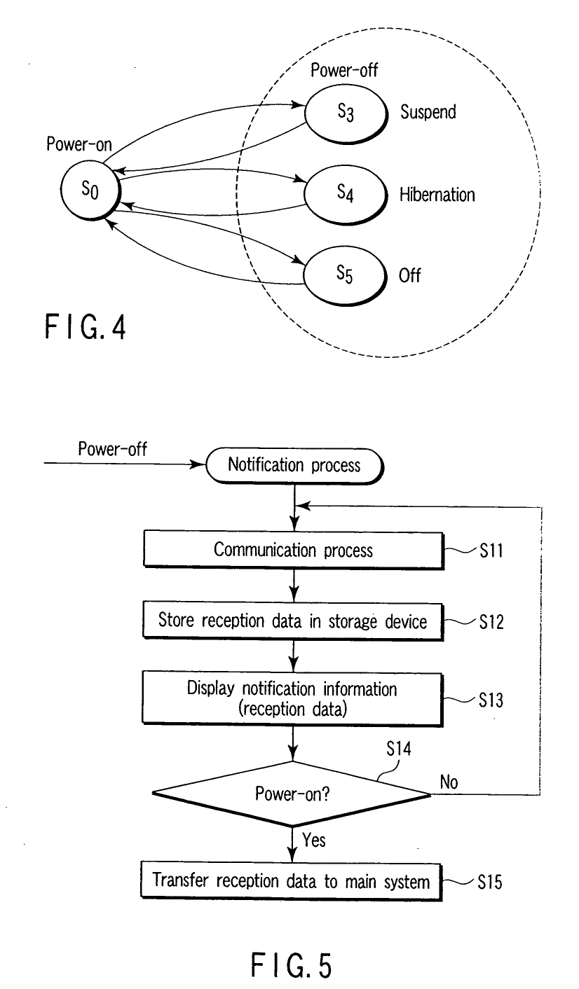

FIG. 4 illustrates transition of system states of the computer 10. The computer 10 supports four system states of S0, S3, S4 and S5. S0 is an operation state (also referred to as “working state”) in which the computer 10 is powered on. In S0, the main system 31 operates under the control of the operating system. S3 (suspend), S4 (hibernation) and S5 (off) are low-power-consumption states in which the computer 10 is powered off. In S3, S4 or S5, the main system 31 does not operate.

In each of S3, S4 and S5, operation power is supplied to the EC/KBC 119, Notification control system 32 and wireless communication device 120.

The Notification function is usable when the computer 10 is set in any one of S3, S4 and S5. Specifically, while the computer 10 is in the power-off state (S3, S4 or S5), the Notification control system 32 operates independently and executes the Notification function. Accordingly, without activating the operating system that runs on the main system 31, data such as e-mail can automatically be received. The data to be received by the Notification function is not limited to the e-mail. For example, a process for receiving a home page from a specific Web server can automatically be executed by the Notification function.

Next, referring to a flow chart of FIG. 5, an example of the basic procedure of the Notification process is described.

If the computer 10, that is, the main system 31 is powered off, the Notification control IC 131 starts to operate. The power-off state refers to one of the above-described system states S3, S4 and S5.

The Notification control IC 131 executes wireless communication with the external device by using the wireless communication device 120, and carries out the communication process for receiving data, such as e-mail, from the external device (block S11). For example, this communication process is executed in response to the reception by the wireless communication device 120 of a signal from the external device, which is indicative of the presence of new e-mail to the computer 10. Specifically, when e-mail to the computer 10 reaches the external device, the external device informs the wireless communication device 120 of the reception of e-mail by a wireless signal. If the wireless communication device 120 receives the information, the Notification control IC 131 starts the above-described communication process and receives the e-mail, whose destination is the computer 10, from the external device. Instead of executing the communication process in response to the information from the external device, the Notification control IC 131 may periodically execute a communication process for determining whether e-mail to the computer 10 reaches the external device, and may receive the e-mail from the external device if the e-mail reaches the external device.

Following block S11, the Notification control IC 131 stores the received data, such as e-mail, in the internal memory 201 or storage device 132 (block S12). Then, the Notification control IC 131 displays on the sub-display 21 the Notification information which indicates the reception of the data such as e-mail (block S13). In block S13, the Notification control IC 131 executes a process of displaying, for example, the header of the received e-mail, on the sub-display 21, or a process of displaying the header and body of the e-mail on the sub-display 21. In this manner, by displaying a part of the reception data on the sub-display 21 as Notification information, the user can easily confirm what kind of e-mail is received.

While the computer 10 is in the power-off state, the Notification control IC 131 executes the process of blocks S11 to S13 each time the wireless communication device 120 receives the above-mentioned information from the external device.

If the computer 10 is powered on (block S14), the Notification control IC 131 stops executing the Notification process. The Notification control IC 131 transfers the received e-mails, which are stored in the internal memory 201 or storage device 132, to the main system 31 (block S115). This transfer process is executed, for example, when the Notification control IC 131 receives a transfer request from the CPU 111 of the main system 31. The CPU 111 stores the received e-mails, which are transferred from the Notification control IC 131, in the receiving tray area in the HDD 115. Thereby, the content of the receiving tray area in the HDD 115 is updated to the latest state. Simply by activating the mailer, the user can easily confirm, on the LCD 20, the content of each of e-mails which have been received while the computer 10 is in the power-off state.

In order to realize low power consumption of the Notification control IC 131, the performance of the Notification control IC 131 is set to be much lower than the performance of the CPU 111 of the main system 31. Consequently, a relatively long time is needed in order to open and display large-volume data, such as an attachment file, on the sub-display 21. In addition, it is difficult to perform, on the Notification control system 32, such works as creation of reply mail to the received e-mail and sending of the reply mail. In this situation, the user may confirm what kind of e-mail is received, on the basis of the Notification information that is displayed on the sub-display 21, and the user may power on the computer 10 if the user judges that a work on the main system 31 is required. Since the e-mail, which is received by the Notification control system 32, is automatically transferred to the HDD 115, the user can perform, only by activating the mailer, such works as confirmation of detailed content of e-mail received by the Notification control system 32, opening and display of the attachment file, and creation of reply mail.

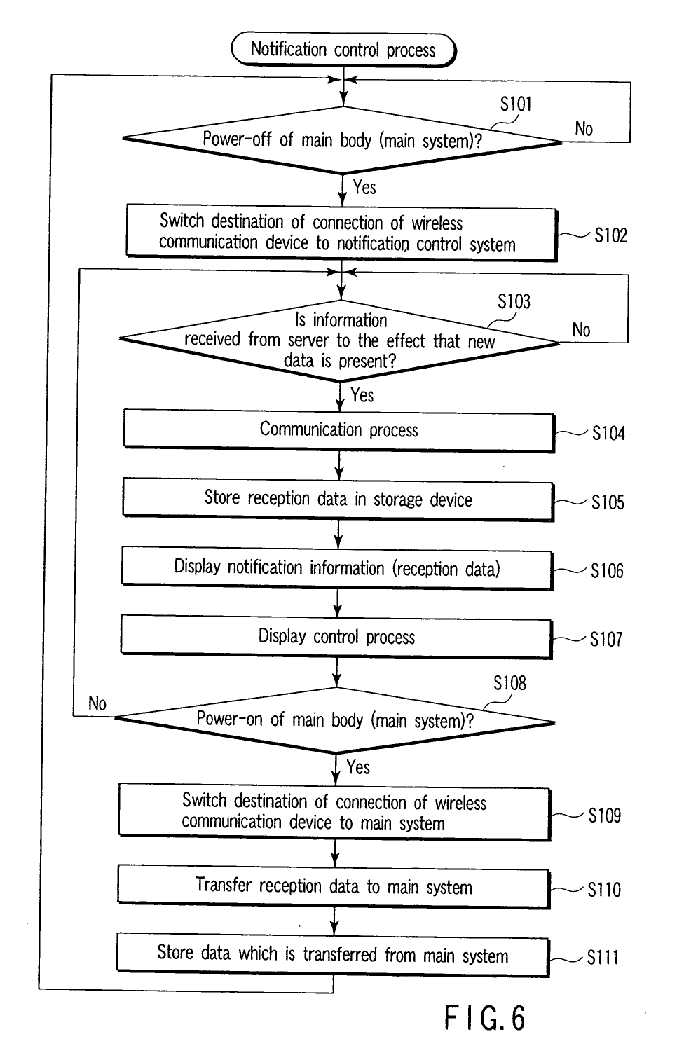

Next, with reference to a flow chart of FIG. 6, an example of a specific procedure of the Notification process, which is executed by the Notification control IC 131, is described.

The Notification control IC 131 monitors a power state signal which is sent from the EC/KBC 116, and determines whether the computer 10, that is, the main system 31, is powered off (S3, S4 or S5) on the basis of the voltage value of the power state signal (block S101). If the computer 10, or the main system 31, is powered off (YES in block S101), the Notification control IC 131 controls the interface switch circuit 121 by a switch control signal, and switches the destination of connection of a host interface (USB interface), which is provided in the wireless communication device 120, from the main system 31 to the Notification control system 32 (block S102).

If the wireless communication device 120 is informed by the external device (mail server) of the presence of new e-mail to the computer 10, the wireless communication device 120 outputs a wakeup signal. The wakeup signal is sent to the Notification control IC 131 via the interface switch circuit 121. Upon receiving the wakeup signal, the Notification control IC 131 determines that information, indicating that new e-mail is present, is received from the external device (mail server) (YES in block S103). The Notification control IC 131 executes wireless communication with the external device (mail server) by using the wireless communication device 120, and executes a communication process for receiving the e-mail to the computer 10 from the external device (mail server) (block S104).

Subsequently, the Notification control IC 131 stores the received e-mail in the internal memory 201 or storage device 132 (block S105). Thereafter, the Notification control IC 131 displays the header, etc. of the received e-mail as Notification information on the sub-display 21 (block S106). In accordance with the operation of the operation switch 22 by the user, the Notification control IC 131 executes a process for displaying the body of the received e-mail on the sub-display and a process for scrolling the display screen of the sub-display 21 (block S107).

If the computer 10 is powered on, the Notification control IC 131 detects that the computer 10, or the main system 31, is powered on, on the basis of the power state signal from the EC/KBC 116 (YES in block S108). The Notification IC 131 controls the interface switch circuit 121 by the switch control signal, and switches the destination of connection of the host interface (USB interface) of the wireless communication device 120 from the Notification control system 32 to the main system 31 (block S109). Under the control of the CPU 111 of the main system 31, the Notification control IC 131 transfers the e-mails stored in the internal memory 201 or storage device 132 to the main system 31 via the USB or I²C bus (block S110).

The main system 31 executes wireless communication with the external device, as needed, by using the wireless communication device 120, and executes an e-mail sending process and an e-mail receiving process. The e-mails, which are received by the wireless communication device 120, are stored in the HDD 115. In addition, the main system 31 transfers the received e-mails to the Notification control IC 131. The Notification control IC 131 stores the e-mails, which are transferred from the main system 31, in the internal memory 201 or storage device 132 (block S111). Thereby, even after the computer 10 is powered off, the user can display on the sub-display 21 the content of each e-mail, which is received by the main system 31, only by operating the operation switch 22.

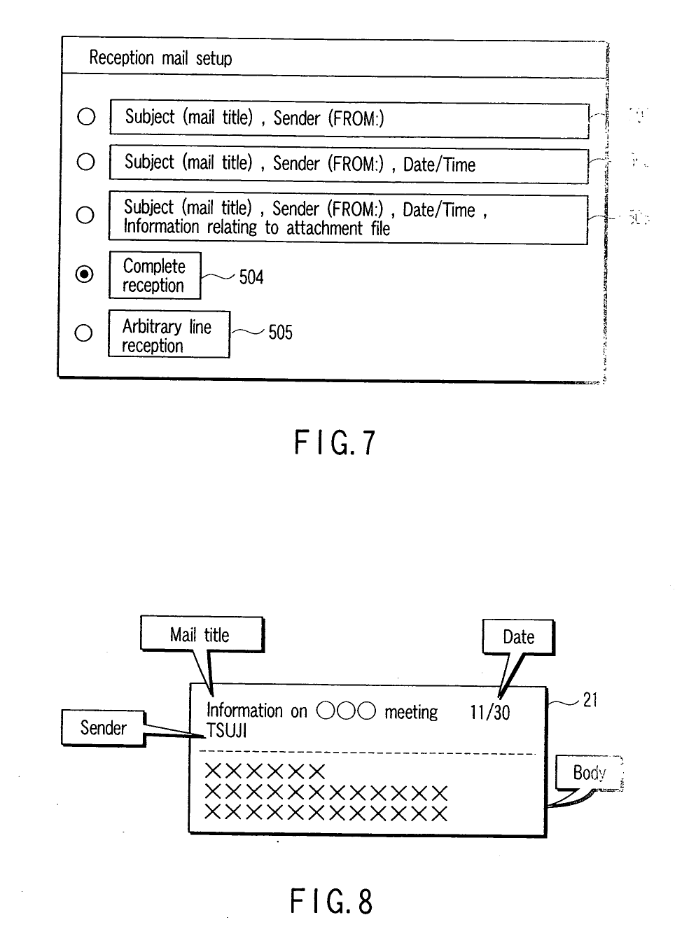

Next, referring to FIG. 7, the content of the communication process, which is executed by the Notification control system 32 in block S104, is described.

FIG. 7 shows an example of a reception mail setup screen for setting the content of the communication process which is to be executed by the Notification control system 32 when information indicating that new e-mail to the computer 10 is present in the external device (mail server) is received from the external device. This setup screen is displayed on the LCD 20, for example, by a utility program that is executed by the CPU 111.

The setup screen displays five choice items 501 to 505 for designating the content of data which is to be received when information indicating that new e-mail to the computer 10 is present in the external device (mail server) is received from the external device. The choice item 501 is an item for designating that the subject (mail title) and the sender should be received. The choice item 502 is an item for designating that the subject (mail title), sender and date/time should be received. The date/time indicates the date/time at which new e-mail is sent. The choice item 503 is an item for designating that the subject (mail title), sender, date/time and information relating to an attachment file (presence/absence of attachment, data size of attachment) should be received. The choice item 504 is an item for designating “complete reception”. When the choice item 504 is selected, a process is executed for receiving not only the header of new e-mail (subject, sender, date/time, and information relating to attachment file) but also the entire body of the new e-mail. The choice item 505 is an item for designating “arbitrary line reception”. When the choice item 505 is selected, a process is executed for receiving not only the header of new e-mail (subject, sender, date/time, and information relating to attachment file) but also data of an arbitrary number of lines of the body of the new e-mail, which is designated by the user.

If one of the choice items 501 to 505 is selected by the user, information indicating the selected choice item is sent from the main system 31 to the Notification control IC 131 via the USB or I²C bus.

FIG. 8 shows an example of Notification information which is displayed on the sub-display 21.

In the case where “complete reception” or “arbitrary line reception” is designated by the user, if information indicating that new e-mail to the computer 10 is present in the external device (mail server) is received from the external device, the Notification control IC 131 executes the process for receiving the header and body of the new e-mail. The Notification control IC 131 displays, as shown in FIG. 8, the mail title, sender, date/time and body on the sub-display 21.

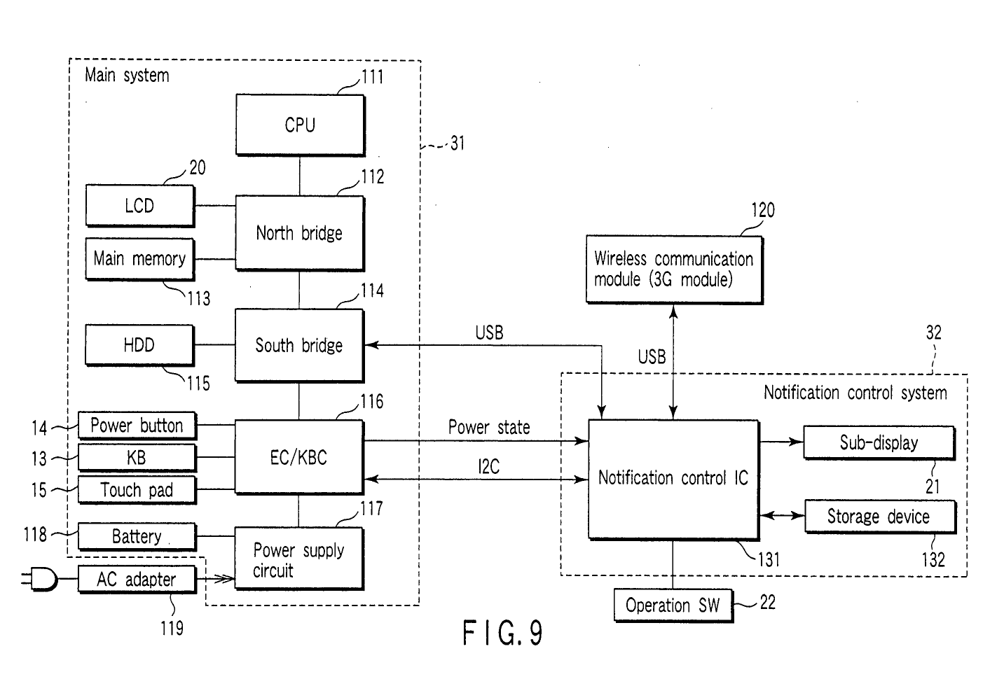

FIG. 9 shows another example of the system configuration of the computer 10.

In the system shown in FIG. 9, the interface switch circuit 121, which has been described with reference to FIG. 3, is built in the Notification control IC 131. The Notification control IC 131 functions as a USB bridge. Specifically, while the computer 10 is in the power-on state, the Notification control IC 131 connects the main system 31 and wireless communication device 120. While the computer 10 is in the power-off state, the Notification control IC 131 executes communication with the wireless communication device 120.

In the system configuration shown in FIG. 9, too, the main system 31 and Notification control system 32 are electrically connected to the wireless communication device 120. Thus, the wireless communication device 120 can be shared by the main system 31 and Notification control system 32.

As has been described above, in the computer 10 of this embodiment, the communication process for receiving data from the external device can be executed by the Notification control system 32. Thus, while the computer 10 is kept in the power-off state, it is possible to receive data from the external device and to store the received data in the storage device. Therefore, data, such as e-mail, can be received at any time without activating the operating system.

In the present embodiment, the case in which the main system 31 and Notification control system 32 are connected to the wireless communication device 120 via USB interfaces has been described by way of example. The interface in this case is not limited to the USB interface, and other interfaces, such as PCI Express, may be used.

Besides, the Notification function may be executed by using, instead of the wireless communication device 120, a communication device which executes communication with the external device via a wired LAN.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a wireless communication device which is provided in the main body;
a first system which is provided in the main body and is configured to operate under a control of an operating system, the first system executing, when the main body is in a power-on state, a process of performing wireless communication with an external device by using the wireless communication device and receiving data from the external device, and a process of storing the received data in a first storage device; and
a second system which is provided in the main body and is configured to operate independently from the first system, the second system executing, when the main body is in a power-off state, a communication process of performing wireless communication with the external device by using the wireless communication device and receiving data from the external device, and a process of storing the received data in a second storage device.

2. The information processing apparatus according to claim 1, wherein the second system is connected to the first system and is configured to execute, after the main body is powered on, a process of transferring the received data, which is stored in the second storage device, to the first system.

3. The information processing apparatus according to claim 1, further comprising a display device which displays data, which is received by the second system, when the main body is in the power-off state.

4. The information processing apparatus according to claim 1, wherein the communication process by the second system is executed in response to reception by the wireless communication device of a signal from the external device, which is indicative of presence of new e-mail.

5. The information processing apparatus according to claim 1, further comprising a switch circuit which selectively connects the first system and the second system to the wireless communication device, the switch circuit connecting the second system to the wireless communication device in response to power-off of the main body, and connecting the first system to the wireless communication device in response to power-on of the main body.

6. An information processing apparatus comprising:
a main body including a base unit and a display unit which is attached to the base unit and is rotatable between a closed position where a top surface of the base unit is covered by the display unit and an open position where the top surface of the base unit is exposed;
a sub-display which is provided at a position on the main body, where the position is exposed in a state in which the display unit is in the closed position;
a wireless communication device which is provided in the main body;
a first system which is provided in the main body, is configured to operate under a control of an operating system and is electrically connected to the wireless communication device, the first system executing, when the main body is in a power-on state, a process of performing wireless communication with an external device by using the wireless communication device and receiving data from the external device, and a process of storing the received data in a first storage device; and
a second system which is provided in the main body, is configured to operate independently from the first system and is electrically connected to the wireless communication device, the second system executing, when the main body is in a power-off state, a communication process of performing wireless communication with the external device by using the wireless communication device and receiving data from the external device, a process of storing the received data in a second storage device, and a process of displaying the received data on the sub-display, and the second system executing, when the main body is powered on, a process of transferring the received data, which is stored in the second storage device, to the first system.

7. The information processing apparatus according to claim 6, further comprising a switch circuit which selectively connects the first system and the second system to the wireless communication device, the switch circuit connecting the second system to the wireless communication device in response to power-off of the main body, and connecting the first system to the wireless communication device in response to power-on of the main body.

8. The information processing apparatus according to claim 6, wherein the communication process by the second system is executed in response to reception by the wireless communication device of a signal from the external device, which is indicative of presence of new e-mail.

9. A communication control method for controlling wireless communication with an external device, which is executed by an information processing apparatus, the method comprising:
causing a first system, which is configured to operate under a control of an operating system, to execute, when the information processing apparatus is in a power-on state, a process of performing wireless communication with the external device by using a wireless communication device which is provided in the information processing apparatus, and a process of storing data, which is received by the wireless communication, in a first storage device; and
causing a second system, which is configured to operate independently from the first system, to execute, when the information processing apparatus is in a power-off state, a communication process of performing wireless communication with the external device by using the wireless communication device, and a process of storing data, which is received by the wireless communication, in a second storage device.

10. The communication control method according to claim 9, further comprising executing, after the information processing apparatus is powered on, a process of transferring the data, which is stored in the second storage device, to the first system.

11. The communication control method according to claim 9, further comprising displaying, on a display device which is provided on the information processing apparatus, data which is received by the second system, when the information processing apparatus is in the power-off state.

12. The communication control method according to claim 9, wherein the communication process by the second system is executed in response to reception by the wireless communication device of a signal from the external device, which is indicative of presence of new e-mail.

13. The communication control method according to claim 9, wherein the information processing apparatus includes a switch circuit which selectively connects the first system and the second system to the wireless communication device, and
the communication control method further comprises connecting the second system to the wireless communication device by controlling the switch circuit in response to power-off of the information processing apparatus; and
connecting the first system to the wireless communication device by controlling the switch circuit in response to power-on of the information processing apparatus.
